(19) United States
(12) Patent Application Publication
(10) Pub. No.: US 2026/0044553 A1
(43) Pub. Date: Feb. 12, 2026

(54) APPARATUS AND METHOD FOR CONSTRUCTING CAPTIONING DATA FOR IMAGES

(71) Applicant: CHUNG ANG UNIVERSITY INDUSTRY ACADEMIC COOPERATION FOUNDATION, Seoul (KR)

(72) Inventors: YOUNG BIN KIM, Seoul (KR); JUHWAN CHOI, Seoul (KR)

(21) Appl. No.: 19/295,777

(22) Filed: Aug. 11, 2025

(30) Foreign Application Priority Data
Aug. 9, 2024 (KR) 10-2024-0107178

(51) Int. Cl. G06F 16/34; G06F 40/58

(52) U.S. Cl. CPC G06F 16/345; G06F 40/58

(57) ABSTRACT

An apparatus for constructing captioning data according to an embodiment is provided with one or more processors and a memory storing one or more programs executed by the one or more processors, and includes an input module configured to acquire input sentences for an image for which captions are to be acquired, and a generation module configured to generate a captioning dataset by paraphrasing and translating the input sentences to generate a plurality of paraphrased and translated sentences and using the plurality of generated paraphrased and translated sentences as a set.

### CROSS-REFERENCE TO RELATED APPLICATION AND CLAIM OF PRIORITY

This application claims the benefit under 35 USC § 119 of Korean Patent Application No. 10-2024-0107178, filed on Aug. 9, 2024, in the Korean Intellectual Property Office, the entire disclosure of which is incorporated herein by reference for all purposes.

### BACKGROUND

### 1. Technical Field

Embodiments of the present disclosure relate to an apparatus and method for constructing captioning data.

### 2. Description of Related Art

In the use of computing devices and artificial intelligence technology, the accumulation of data that serves as the basis for implementing the computing device and artificial intelligence technology is an important part.

FIG. 1 is a schematic diagram for describing a conventional method for constructing image caption data. Referring to FIG. 1, in the past, in accumulating captioning data for images, a method in which human annotators using each language directly input captions into a computing device has been used. However, this method requires a lot of cost and time, and has a problem in that it is not easy to obtain captioning data for languages with few users. Accordingly, in constructing captioning data for images, a technology is needed that minimizes the intervention of human resources, minimizes costs, and makes it easy to construct captioning data even for languages with few users.

Examples of related art include Korean Unexamined Patent Publication Application No. 10-2024-0001239 (2024.01.03)

### SUMMARY

Embodiments of the present disclosure are directed to providing an apparatus and method for constructing captioning data that minimizes the intervention of human annotators, minimizes costs, and makes it easy to construct captioning data even for languages with few users.

An apparatus for constructing captioning data according to an embodiment of the present disclosure is provided with one or more processors and a memory storing one or more programs executed by the one or more processors, and includes an input module configured to acquire input sentences for an image for which captions are to be acquired, and a generation module configured to generate a captioning dataset by paraphrasing and translating the input sentences to generate a plurality of paraphrased and translated sentences and using the plurality of generated paraphrased and translated sentences as a set.

The generation module may be configured to paraphrase one of the input sentences into N expressions and translate the N expressions into M languages to generate the N*M paraphrased and translated sentences.

The generation module may be configured to paraphrase the input sentences into a plurality of expressions to generate a plurality of paraphrased sentences, translate each of the plurality of paraphrased sentences into a plurality of languages to generate paraphrased and translated sentences, and generate a set of the paraphrased and translated sentences as the captioning dataset.

The generation module may be configured to paraphrase one of the input sentences to generate N paraphrased sentences and translate each of the N paraphrased sentences into M languages to generate M translated sentences for each of the N paraphrased sentences, thereby generating L*N*M paraphrases and translated sentences when the number of the input sentences acquired is L.

The generation module may be configured to translate the input sentences into a plurality of languages to generate a plurality of translated sentences, paraphrase each of the plurality of translated sentences into a plurality of expressions to generate paraphrased and translated sentences, and generate a set of the paraphrased and translated sentences as the captioning dataset.

The generation module may be configured to translate one of the input sentences to generate M translated sentences and paraphrase each of the M translated sentences into N expressions to generate N paraphrased sentences for each of the M translated sentences, thereby generating L*N*M paraphrases and translated sentences when the number of the input sentences acquired is L.

A method for constructing captioning data according to an embodiment of the present disclosure is performed in a computing device that includes one or more processors and a memory storing one or more programs executed by the one or more processors, the method including acquiring input sentences for an image for which captions are to be acquired, and generating a captioning dataset by paraphrasing and translating the input sentences to generate a plurality of paraphrased and translated sentences and using the plurality of generated paraphrased and translated sentences as a set.

A computer program according to an embodiment of the present disclosure is stored in a non-transitory computer readable storage medium, in which the computer program includes one or more instructions, and the instructions, when executed by a computing device including one or more processors, cause the computing device to perform acquiring input sentences for an image for which captions are to be acquired and generating a captioning dataset by paraphrasing and translating the input sentences to generate a plurality of paraphrased and translated sentences and using the plurality of generated paraphrased and translated sentences as a set.

### BRIEF DESCRIPTION OF THE DRAWINGS

The present disclosure may be easily understood by combining the following detailed description and the accompanying drawings, in which reference numerals represent structural elements.

FIG. 1 is a schematic diagram for describing a conventional method for constructing captioning data.

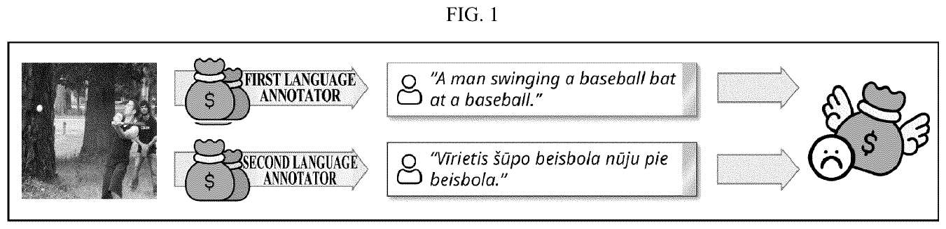

FIG. 2 is a block diagram for describing a configuration of an apparatus for constructing captioning data according to an embodiment of the present disclosure.

FIG. 3 is a schematic diagram for describing a method for constructing captioning data according to an embodiment of the present disclosure.

FIG. 4 is a flowchart for describing a method for constructing captioning data according to an embodiment of the present disclosure.

FIG. 5 is a flowchart for describing a method for constructing FIG. 5 is a flowchart for describing a method for constructing captioning data according to another embodiment of the present disclosure.

FIG. 6 is a block diagram for describing a computing environment including a computing device suitable for use in exemplary embodiments.

### DETAILED DESCRIPTION

Hereinafter, specific embodiments of the present invention will be described with reference to the drawings. The following detailed description is provided to facilitate a comprehensive understanding of the methods, apparatuses, and/or systems described herein. However, this is only an example and the present invention is not limited thereto.

In describing embodiments of the present invention, if it is determined that a specific description of a related known function of the preset invention may unnecessarily obscure the gist of the present invention, the detailed description thereof will be omitted. The terms described below are terms defined in consideration of the functions in the present invention, and vary depending on the intention or custom of the user or operator. Therefore, the definition should be made based on the contents throughout this specification. The terminology used in the detailed description is for the purpose of describing embodiments of the present invention only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present invention, a first component may be referred to as a second component, and similarly, a second component may also be referred to as a first component.

In this specification, an “apparatus for constructing captioning data 100” may acquire an input sentence for an image for which captions is to be acquired and paraphrase and translate the input sentence to generate a captioning dataset.

The apparatus for constructing captioning data 100 may include one or more processors necessary for paraphrasing and translating input sentences and a computer-readable recording medium connected to the processor, and may further include a database for storing data. The computer-readable recording medium may be placed inside or outside the processor, and may be connected to the processor by various well-known means. The processor in the apparatus for constructing captioning data 100 may cause the apparatus for constructing captioning data 100 to operate according to an exemplary embodiment described in this specification. For example, the processor may execute instructions stored on the computer-readable recording medium, and the instructions stored on the computer-readable recording medium, when executed by the processor, may be configured to cause the apparatus for constructing captioning data 100 to perform operations according to exemplary embodiments described herein.

In this specification, “input sentences” may be sentences obtained by providing a plurality of images to be annotated to an annotator and being input by the annotator. The input sentences may be caption sentences for a specific image. The caption sentences may be sentences for describing the corresponding image or provide additional information about the corresponding image.

In this specification, “paraphrased sentences” may be sentences generated by paraphrasing the input sentences. Specifically, a plurality of paraphrased sentences may be generated by paraphrasing each of a plurality of input sentences into one or more new expressions.

In the present specification, “paraphrase” may mean to express the same content in context of one sentence in another sentence using one or more of different words and different expressions.

In this specification, “translated sentences” may be data generated by translating input sentences. Specifically, a plurality of translated sentences may be generated by translating each of a plurality of input sentences into one or more new languages.

In this specification, “captioning dataset” may be information that is a set of sentences generated by paraphrasing input sentences into a plurality of expressions and translating them into a plurality of languages. In an exemplary embodiment, the captioning dataset may be generated by translating paraphrased sentences. Alternatively, the captioning dataset may be generated by paraphrasing translated data.

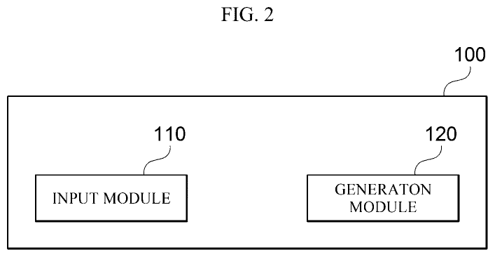

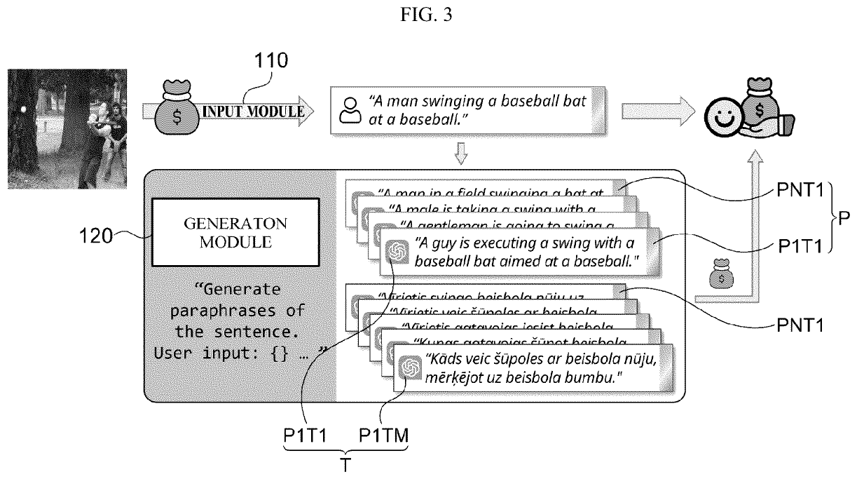

FIG. 2 is a block diagram for describing a configuration of an apparatus for constructing captioning data according to an embodiment of the present disclosure and FIG. 3 is a schematic diagram for describing a method for constructing captioning data according to an embodiment of the present disclosure.

Referring to FIGS. 2 and 3, the apparatus for constructing captioning data 100 may include an input module 110 and a generation module 120.

The input module 110 may acquire sentences input for an image for which captions are to be acquired. Specifically, the input module 110 may provide a plurality of images for which captions are to be acquired to an annotator, and acquire sentences input by the annotator for the provided images. The input sentences may be caption sentences for the provided images. The caption sentences may be sentences that describe the provided images or provide additional information for the provided images. The input module 110 may acquire a plurality of input sentences for a plurality of images. The input module 110 may transfer the input sentences to the generation module 120 to paraphrase and translate the input sentences.

The generation module 120 may paraphrase and translate the input sentences to generate a plurality of paraphrased and translated sentences, and may generate a captioning dataset by using the generated sentences as a set.

Specifically, the generation module 120 may receive the input sentences from the input module 110. The generation module 120 may paraphrase each of the plurality of input sentences into a plurality of expressions to generate paraphrased sentences. The paraphrase may mean to express the same content in context of one sentence in another sentence using one or more of different words and different expressions. Alternatively, the generation module 120 may translate each of the plurality of input sentences into a plurality of languages to generate translated sentences.

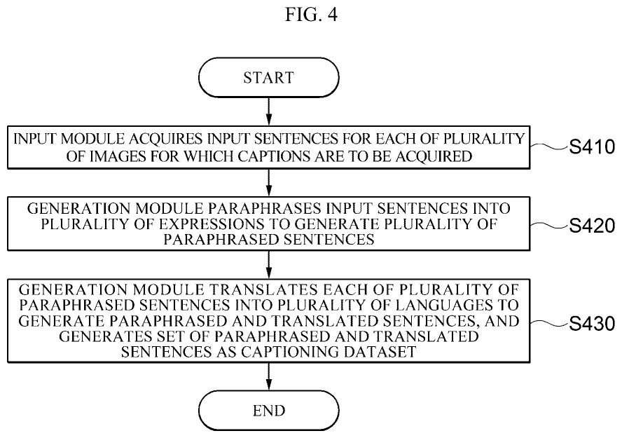

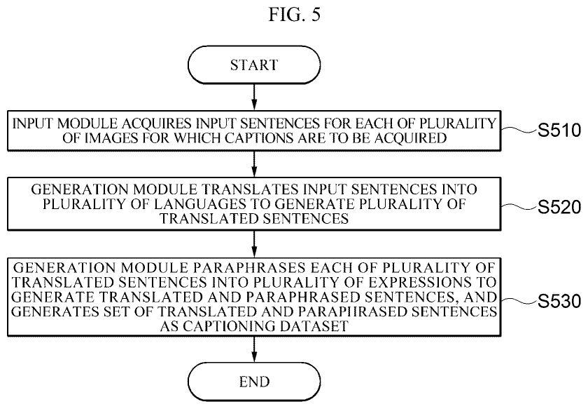

The generation module 120 may generate N*M paraphrased and translated sentences by paraphrasing one input sentence into N expressions and translating the paraphrased N expressions into M languages. When the generation module 120 acquires input sentences for L images, the generation module 120 may generate L*N*M paraphrased and translated sentences. The generation module 120 may translate the input sentences after paraphrasing them, or may paraphrase the input sentences after translating them. For a more specific description of this, refer to FIGS. 4 and 5 below.

FIG. 4 is a flowchart for describing a method for constructing captioning data according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 4, in step S410, the input module 110 may acquire input sentences each of which is for each of a plurality of images for which captions are to be acquired.

Specifically, the input module 110 may provide the plurality of images for which captions are to be acquired to the annotator, and acquire input sentences from the annotator for the provided images. The input module 110 may acquire a plurality of input sentences corresponding to each of the multiple images in a one-to-one relationship. The plurality of input sentences may be sentences written in a common language.

Next, in step S420, the generation module 120 may paraphrase the input sentences into a plurality of expressions to generate a plurality of paraphrased sentences. Specifically, the generation module 120 may paraphrase P one input sentence to generate N paraphrased sentences P1T1 to PNT1.

Next, in step S430, the generation module 130 may translate each of the plurality of paraphrased sentences into a plurality of languages to generate paraphrased and translated sentences, and may generate a set of paraphrased and translated sentences as a captioning dataset.

Specifically, the generation module 120 may translate each of the paraphrased sentences into a plurality of languages to generate a plurality of paraphrased and translated sentences. Specifically, the generation module 120 may translate T each of the N paraphrased sentences P1T1 to PNT1 into M languages to generate M translated sentences P1T1 to P1TM for each paraphrased sentence.

Accordingly, the generation module 120 may generate N*M paraphrased and translated sentences from one input sentence. When the generation module 120 acquires input sentences for L images, the generation module 120 may generate L*N*M paraphrased and translated sentences. The generation module 120 may generate a captioning dataset by using

L*N*M paraphrased and translated sentences as a set.

FIG. 5 is a flowchart for describing a method for constructing FIG. 5 is a flowchart for describing a method for constructing captioning data according to another embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown).

Referring to FIG. 5, in step S510, the input module 110 may acquire input sentences for each of the plurality of images for which captions are to be acquired.

Specifically, the input module 110 may provide a plurality of images for which captions are to be acquired to the annotator, and acquire input sentences from the annotator for the provided images. The input module 110 may acquire a plurality of input sentences corresponding to each of the plurality of images in a one-to-one relationship. The plurality of input sentences may be sentences written in a common language.

Next, in step S520, the generation module 130 may translate the input sentences into a plurality of languages to generate a plurality of translated sentences. Specifically, the generation module 120 may translate each of the plurality of input sentences into a plurality of languages to generate translated sentences. The generation module 120 may translate T one input sentence to generate M translated sentences P1T1 to P1TM.

Next, in step S530, the generation module 120 may paraphrase each of the plurality of translated sentences into a plurality of expressions to generate translated and paraphrased sentences, and generate a set of translated and paraphrased sentences as a captioning dataset.

Specifically, the generation module 120 may paraphrase each of the translated sentences into a plurality of expressions to generate a plurality of translated and paraphrased sentences. Specifically, the generation module 120 may paraphrase P each of the M translated sentences P1T1 to P1TM into N expressions to generate N paraphrased sentences P1T1 to PNT1 for each translated sentence.

Accordingly, the generation module 120 may generate M*N translated and paraphrased sentences from one input sentence. When the generation module 120 acquires input sentences for L images, the generation module 120 may generate L*M*N translated and paraphrased sentences. The generation module 120 may generate a captioning data set by using L*M*N translated and paraphrased sentences as a set.

According to the embodiments of the present disclosure, in constructing captioning data for images, it is possible to minimize the intervention of human resources, minimize costs, and makes it easy to construct captioning data even for languages with few users.

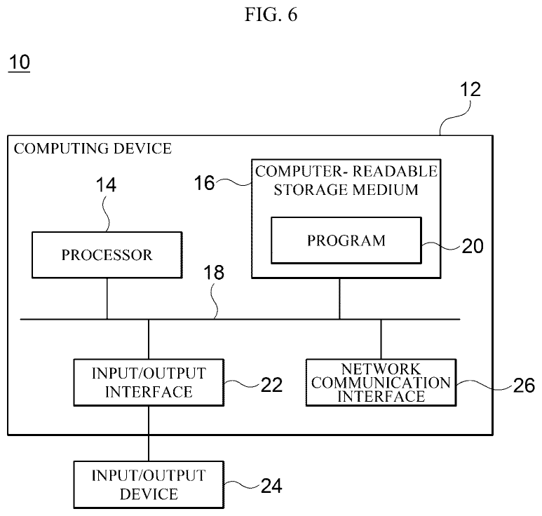

FIG. 6 is a block diagram for illustratively describing a computing environment including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be an apparatus for detecting profanity 100.

The input module 110 of FIGS. 2 and 3 may correspond to the input/output device 24 of FIG. 6, and the generation module 120 of FIGS. 2 and 3 may correspond to the processor 14 of FIG. 6.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Although representative embodiments of the present invention have been described in detail above, those skilled in the art will understand that various modifications may be made to the above-described embodiments without departing from the scope of the present invention. Therefore, the scope of the present invention should not be limited to the described embodiments, but should be defined not only by the patent claims described below but also by those equivalent to the patent claims.

What is claimed is:

1. An apparatus for constructing captioning data including one or more processors and a memory storing one or more programs executed by the one or more processors, the apparatus comprising:
an input module configured to acquire input sentences for an image for which captions are to be acquired; and
a generation module configured to generate a captioning dataset by paraphrasing and translating the input sentences to generate a plurality of paraphrased and translated sentences and using the plurality of generated paraphrased and translated sentences as a set.

2. The apparatus of claim 1, wherein the generation module is configured to paraphrase one of the input sentences into N expressions and translate the N expressions into M languages to generate the N*M paraphrased and translated sentences.

3. The apparatus of claim 1, wherein the generation module is configured to:
paraphrase the input sentences into a plurality of expressions to generate a plurality of paraphrased sentences; and
translate each of the plurality of paraphrased sentences into a plurality of languages to generate paraphrased and translated sentences and generate a set of the paraphrased and translated sentences as the captioning dataset.

4. The apparatus of claim 3, wherein the generation module is configured to:
paraphrase one of the input sentences to generate N paraphrased sentences; and
translate each of the N paraphrased sentences into M languages to generate M translated sentences for each of the N paraphrased sentences, thereby generating L*N*M paraphrases and translated sentences when the number of the input sentences acquired is L.

5. The apparatus of claim 1, wherein the generation module is configured to:
translate the input sentences into a plurality of languages to generate a plurality of translated sentences; and
paraphrase each of the plurality of translated sentences into a plurality of expressions to generate paraphrased and translated sentences and generate a set of the paraphrased and translated sentences as the captioning dataset.

6. The apparatus of claim 5, wherein the generation module is configured to:
translate one of the input sentences to generate M translated sentences; and
paraphrase each of the M translated sentences into N expressions to generate N paraphrased sentences for each of the M translated sentences, thereby generating L*N*M paraphrases and translated sentences when the number of the input sentences acquired is L.

7. A method for constructing captioning data performed in a computing device that includes one or more processors and a memory storing one or more programs executed by the one or more processors, the method comprising:
acquiring input sentences for an image for which captions are to be acquired; and
generating a captioning dataset by paraphrasing and translating the input sentences to generate a plurality of paraphrased and translated sentences and using the plurality of generated paraphrased and translated sentences as a set.

8. The method of claim 7, wherein, in the generating of the captioning dataset, one of the input sentences is paraphrased into N expressions and the N expressions are translated into M languages to generate the N*M paraphrased and translated sentences.

9. The method of claim 7, wherein, in the generating of the captioning dataset, the input sentences are paraphrased into a plurality of expressions to generate a plurality of paraphrased sentences, and
each of the plurality of paraphrased sentences is translated into a plurality of languages to generate paraphrased and translated sentences, and a set of the paraphrased and translated sentences is generated as the captioning dataset.

10. The method of claim 9, wherein, in the generating of the captioning dataset, one of the input sentences is paraphrased to generate N paraphrased sentence, and
each of the N paraphrased sentences is translated into M languages to generate M translated sentences for each of the N paraphrased sentences, thereby generating L*N*M paraphrased and translated sentences when the number of the input sentences acquired is L.

11. The method of claim 7, wherein, in the generating of the captioning dataset, the input sentences are translated into a plurality of languages to generate a plurality of translated sentences, and
each of the plurality of translated sentences is paraphrased into a plurality of expressions to generate paraphrased and translated sentences, and a set of the paraphrased and translated sentences is generated as the captioning dataset.

12. The method of claim 11, wherein, in the generating of the captioning dataset, one of the input sentences is translated to generate M translated sentences, and
each of the M translated sentences is paraphrased into N expressions to generate N paraphrased sentences for each of the M translated sentences, thereby generating L*N*M paraphrased and translated sentences when the number of the input sentences acquired is L.

13. A computer program stored in a non-transitory computer readable storage medium, in which the computer program includes one or more instructions, and the instructions, when executed by a computing device including one or more processors, cause the computing device to perform:
acquiring input sentences for an image for which captions are to be acquired; and
generating a captioning dataset by paraphrasing and translating the input sentences to generate a plurality of paraphrased and translated sentences and using the plurality of generated paraphrased and translated sentences as a set.

14. The computer program of claim 13, wherein, in the generating of the captioning dataset, the input sentences are paraphrased into a plurality of expressions to generate a plurality of paraphrased sentences, and
each of the plurality of paraphrased sentences is translated into a plurality of languages to generate paraphrased and translated sentences, and a set of the paraphrased and translated sentences is generated as the captioning dataset.

15. The computer program of claim 13, wherein, in the generating of the captioning dataset, the input sentences are translated into a plurality of languages to generate a plurality of translated sentences, and
each of the plurality of translated sentences is paraphrased into a plurality of expressions to generate paraphrased and translated sentences, and a set of the paraphrased and translated sentences is generated as the captioning dataset.
